(19) United States
(12) Patent Application Publication
(10) Pub. No.: US 2008/0119373 A1
(43) Pub. Date: May 22, 2008

(54) Receptor Specific Binder Discovery Using Intramolecular Acyl Migration Induced Dynamic Carbohydrate Library

(75) Inventor: Young-Tae Chang, New York, NY (US)

Correspondence Address: BROWDY AND NEIMARK, P.L.L.C.;624 NINTH STREET, NW, SUITE 300, WASHINGTON, DC, 20001-5303, US

(73) Assignee: New York University, New York, NY (US)

(21) Appl. No.: 10/574,487

(22) PCT Filed: Oct. 1, 2004
(86) PCT No.: PCT/US04/32341

§ 371 Date: Dec. 11, 2007

Related U.S. Application Data
(60) Provisional application No. 60/507,514, filed on Oct. 2, 2003.

(51) Int. Cl. C40B 50/14

(52) U.S. Cl. 506/30

(57) ABSTRACT

An efficient molecular evolution system was obtained by combining two novel approaches in the field, intramolecular acyl migration for DCL generation and boronic acid as a selector. 1,4-Di-O-benzoyl chiro-inositol in acetonitrile with DBU as a base generated a reversible equilibrium of 9 regioisomers. Only 3,4-di-O-benzoyl chiro-inositol, containing two sets of cis-diols, is most favored toward binding with phenyl boronic acid, and its percentage of the DCL composition was amplified by up to 82%.

### FIELD OF THE INVENTION

The present invention provides a highly efficient molecular evolution system using intramolecular acyl migration on a carbohydrate scaffold coupled with boronic acid as a selector.

### BACKGROUND OF THE INVENTION

Evolution through natural selection underlies much of current theory of the biological world, from the molecular to the species level. Much effort has been expended trying to realize evolutionary phenomena at the molecular level (Otto et al., 2002; Furlan et al., 2002; Karan et al., 2000; Rowan et al., 2002). Dynamic combinatorial chemistry enabled functional features of evolution such as a diversity generation system (mutations) and survival of the fittest (natural selection).

A dynamic combinatorial library can be visualized as a test of transient compounds that undergo a series of reversible equilibrium processes. Under thermodynamic control, the library members interconvert reversibly and continually. The action of the selector drives the system to re-equilibrate, forming an amplified concentration of the molecule with the highest selector binding affinity.

Two key features of molecular evolution are the selection and amplification of a particular species in the dynamic combinatorial library (DCL). A DCL allows for a reversible equilibrium of library members in which a concentration change in one library member results in a new equilibrium distribution following Le Chatelier's principle.

To date, a number of DCLs have been prepared using such diverse chemical reactions as intermolecular transesterification, enzyme catalyzed peptide-bond exchange, imine bond exchanges of hydrazones or oximes, olefin metathesis, disulfide bond exchange, photoisomerization, hydrogen bond exchange, and metal-ligand coordination.

An ideal molecular evolution system requires an even distribution of the DCL components, an efficient selection method, and a non-destructive/continuous equilibrium in order to generate a “winning” binder for amplification.

As molecular evolution needs an effective molecular recognition event for amplification, it is now being evaluated as an efficient approach for identifying and preparing new host-guest systems (Ott et al., 2002; Furlan et al., 2002; Furlan et al., 2001).

Carbohydrate recognition plays an important role in many biological processes, particularly in cell-cell interactions and cell communications. A multitude of regulatory processes are mediated by carbohydrates as ligands for diverse proteins. However, the preparation of carbohydrate libraries by conventional methods has not achieved a satisfactory development because of numerous problems met with carbohydrate synthesis and automation protocols. Although dynamic combinatorial chemistry (DCC) can offer the complementary method to carbohydrate libraries, there have not been many attempts to generate dynamic combinatorial libraries (DCL) on a carbohydrate scaffold because of the complexity, and the selection method was not effective for successful amplification.

### SUMMARY OF THE INVENTION

It is an object of the present invention to overcome the aforesaid deficiencies in the prior art.

It is another object of the present invention to provide a molecular evolution system.

It is yet another object of the present invention to provide a molecular evolution system based on a carbohydrate scaffold

It is a further object of the present invention to produce a dynamic combinatorial library of dimers and oligomers having monomers connected by an ester bond using intramolecular acyl migration.

The present invention provides a highly efficient molecular evolution system using intramolecular acyl migration on a carbohydrate scaffold coupled with boronic acid as a selector.

In the examples described below, hexahydroxyl cyclohexane (inositol) was used for the intramolecular acyl migration system. In these molecules, each free hydroxyl group behaves as a nucleophile by attacking neighboring acyl groups, thus generating various regioisomers. Under basic conditions (pyridine/water), it was previously reported that benzoyl migration on myo-inositol (with 5 equatorial and one axial OH) generates an almost equi-molar amount of 9 regioisomers (Chung et al., 1995; Chung et al., 1996).

To maximize the geometric diversity between regioisomers, chiro-inositol was chosen as a DCL scaffold. Chiro-inositol has 2 vicinal axial-OH and 4 equatorial OH groups. Accordingly, 1, 4-dibenzoyl-chiro-inositol was synthesized (Khersonsky et al., 2002; Falshaw et al., 2000) and investigated for optimization of the DCL generation.

The 1,4-dibenzoyl-chiro-inositol was synthesized and subjected to a benzoyl migration. Under basic conditions, benzoyl migration on the inositol ring generated an almost equi-molar amount of 9 regioisomers. To minimize debenzoylation,-anhydrous acetonitrile was used as the solvent with DBU as the base. The optimal condition consisted of 1 mg 1,4-dibenzoyl-chiro-inositol and 30 microL DBU (1,8-Diazabicyclo[5,4,0]undec-7-ene) in 1 mL acetonitrile. This yielded full migration within one hour at room temperature. Generation of the nine isomers was confirmed by mass spectrometry and UV analysis using LC-MS, as shown in FIG. 1a and FIG. 1b.

Boronic acids can be added to the mixture as a selector, since it is well known that boronic acids form five-membered cyclic esters preferably with 1,2-cis diols in sugar. Adding the boronic acid shifted the equilibrium in favor of one isomer over the others.

### BRIEF DESCRIPTION OF THE DRAWINGS

FIG. 1 shows library members generated by acyl migration and the selected component upon treatment with phenyl boronic acid.

FIGS. 2a-2d show HPLC chromatograms of chiro-1(1,4)Bz.

FIG. 3 illustrates synthesis of 3,4-di-O-benzoyl-chiro-inositol, compound 7.

FIG. 4 shows the effect of phenyl boronic acid on the amplification of 3,4-di-O-benzoyl-chiro-inositol.

FIG. 5 shows time-dependent amplification of 3,4-di-O-benzoyl-chiro-inositol.

FIG. 6 shows synthesis of 3,6-di-O-benzoyl-chiro- inositol, compound 5.

FIG. 7 shows LC-MS diagram of 3,4-di-O-benzoyl-chiro-inositol (7a) and mass data for 3,4-di-O-benzoyl-chiro-inositol (7b).

FIG. 8 shows LC-MS diagram of 3,6-di-O-benzoyl-chiro-inositol (8a) and mass data for 3,6-di-O-benzoyl-chiro-inositol (8b).

FIG. 9 shows a dynamic combinatorial library on an oligosaccharide scaffold.

FIG. 10 shows intramolecular acyl migration of chiro-inositol dibenzoate.

### DETAILED DESCRIPTION OF THE INVENTION

Hexahydroxyl cyclohexane (inositol) was chosen to illustrate the intramolecular acyl migration model system of the present invention. In these molecules, each free hydroxyl group behaves as a nucleophile by attacking neighboring acyl groups, thus. generating various regioisomers. Under basic conditions (pyridine/water), it was previously reported that benzoyl migration on myo-inositol (with five equatorial and 1 axial OH) generates an almost equi-molar amount of nine regioisomers Chung et al., 1995; Chung et al., 1996).

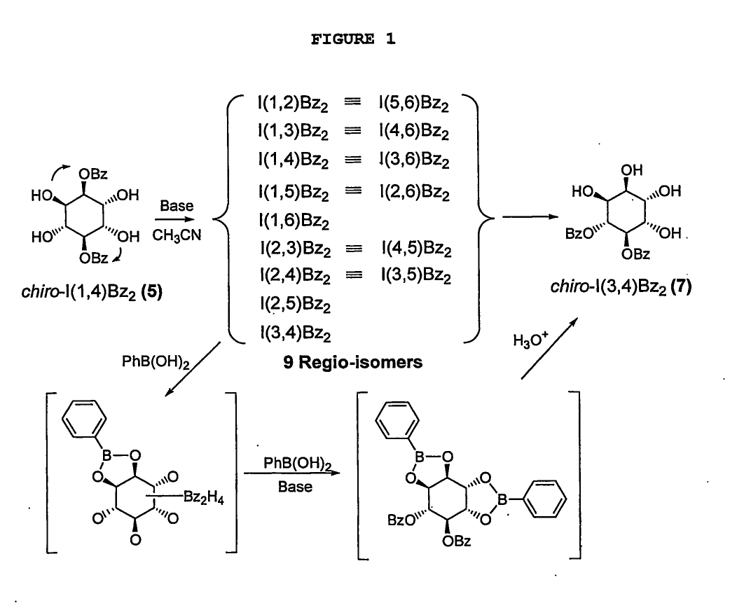

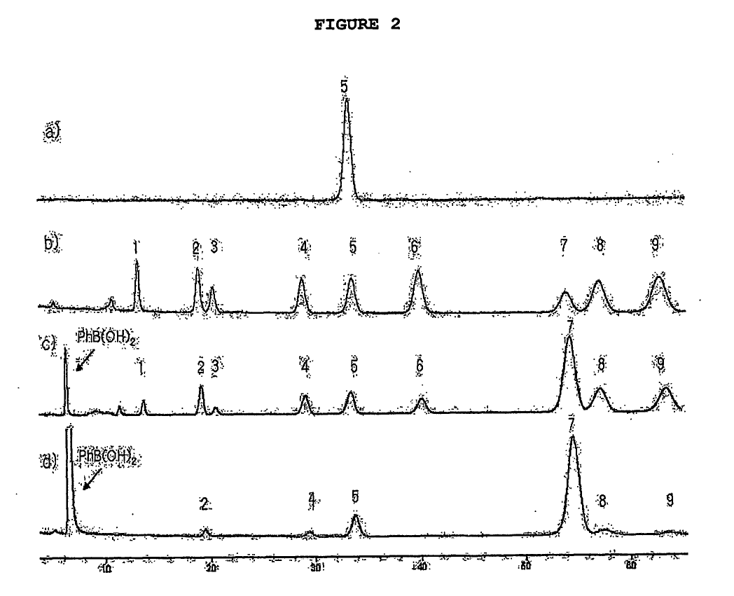

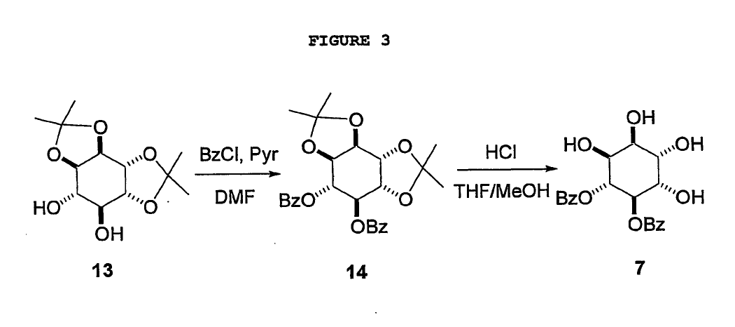

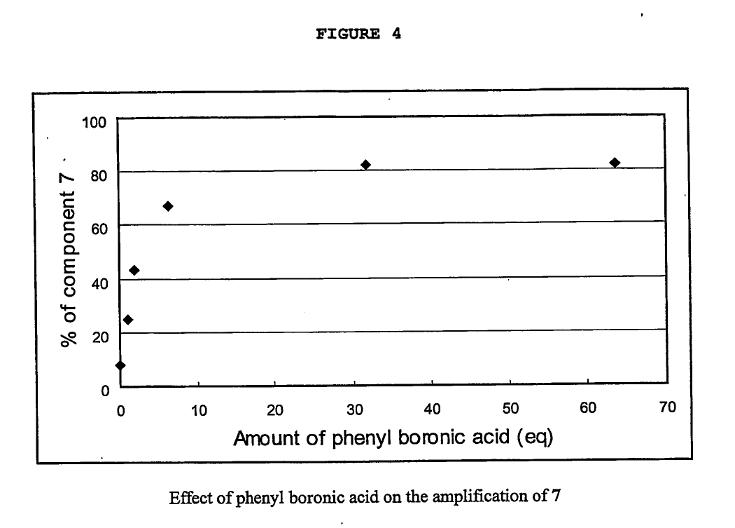

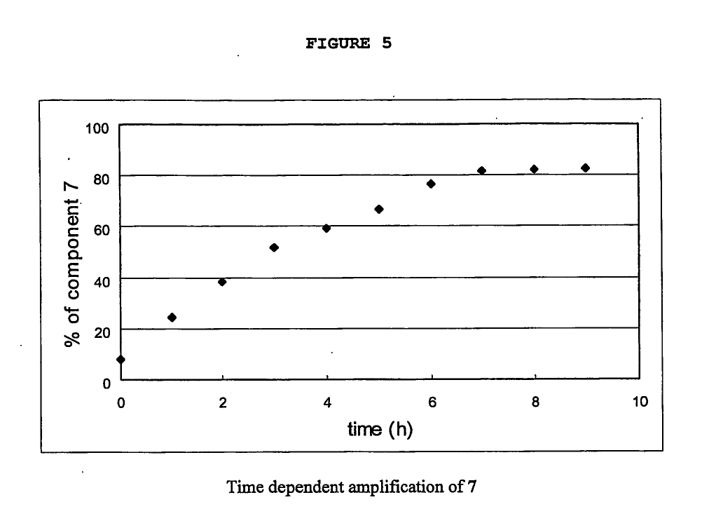

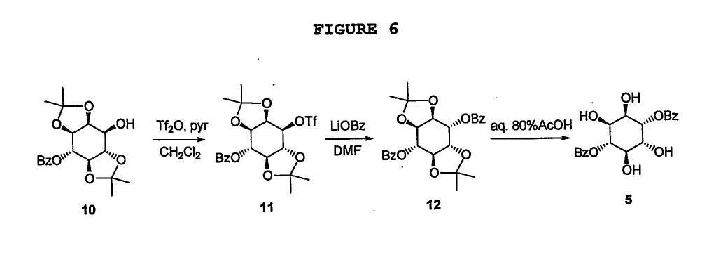

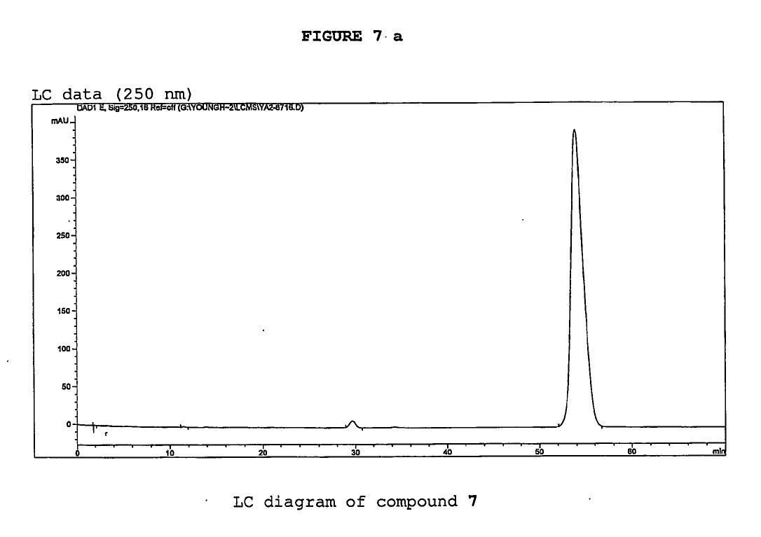

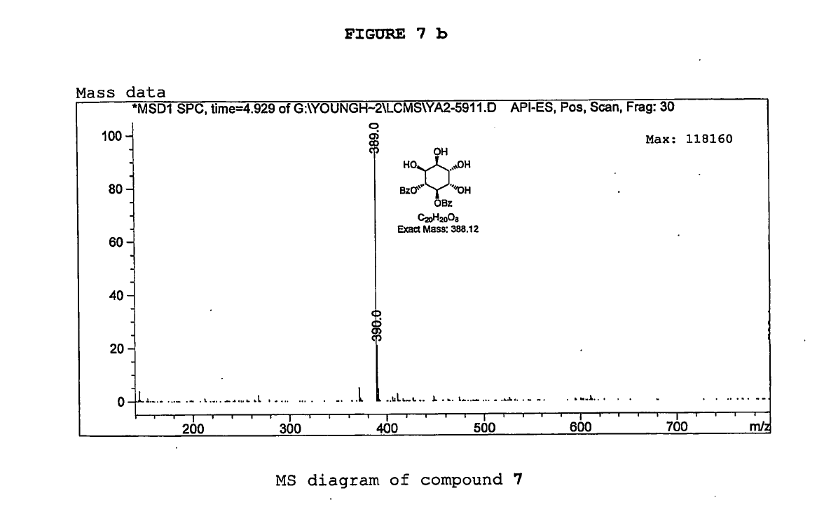

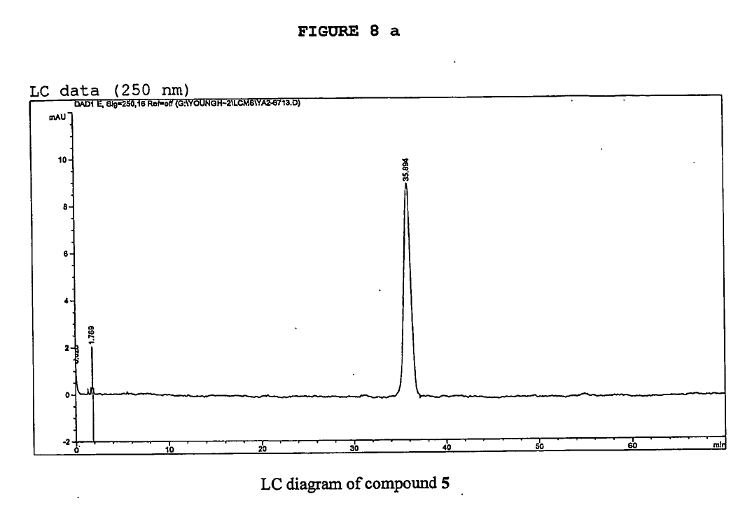

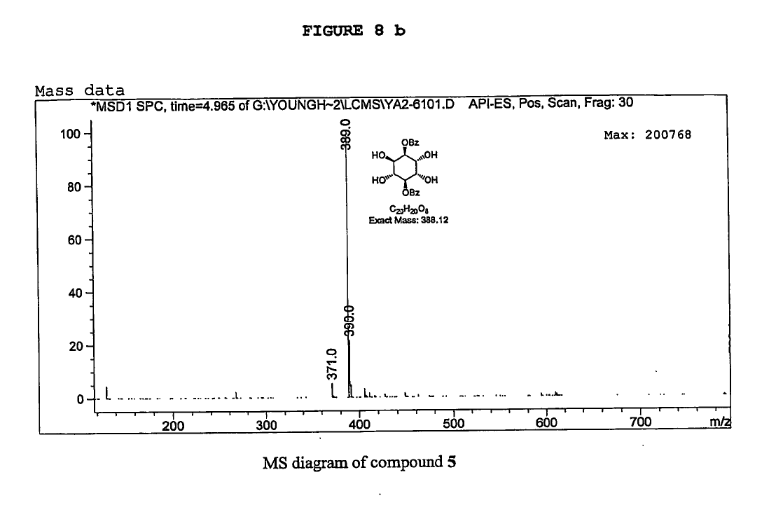

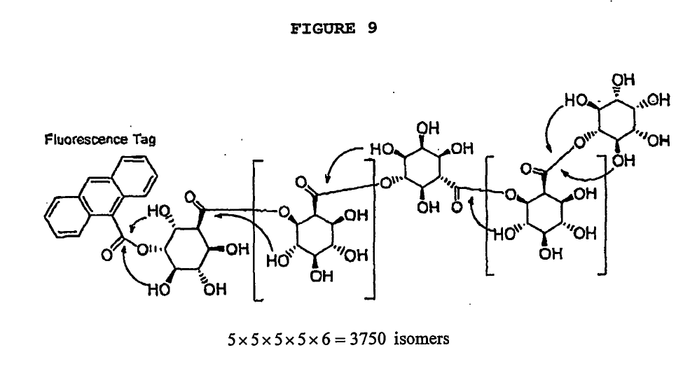

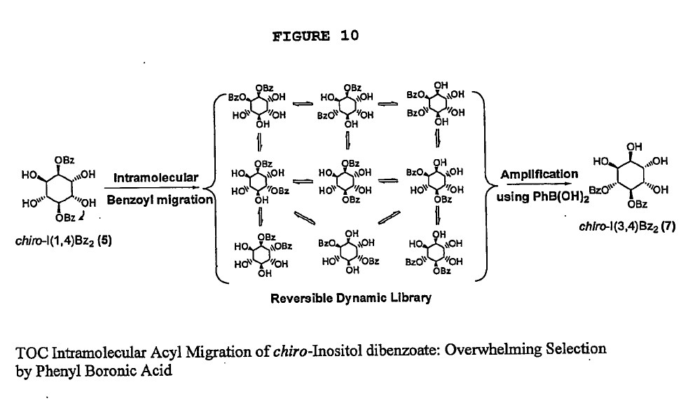

The process of the present invention maximizes the geometric diversity between regioisomers by using chiro-inositol, which has 2 vicinal axial OH groups and 4 equatorial OH groups as a dynamic combinatorial scaffold. Accordingly, 1,4-dibenzoyl-chiro-inositol was synthesized (Khersonsky et al., 2002; Falshaw et al., 2000) and investigated for optimization of the dynamic combinatorial library generation. Chiro-inositol dibenzoate generates a total of nine regioisomers upon full equilibration, as shown in FIG. 1. A series of bases, including pyridine, DMAP (4-Dimethyl-aminopyridine), DABCO (1,4-Diazabicyclo[2,2,2]octane), DIPEA (N,N-Diisopropylethlyamine), BEMP (2-tert-Butylimino-2-diethylamino-1,3-dimethyl-perhydro-1,3,2-diazaphosphorine) on polystyrene, DBU (1,8-Diazabicyclo[5,4,0]undec-7-ene) and NaOH in aprotic solvents (DMF, DMSO, CH₃CN) all with and without water were evaluated. While several conditions induce benzoyl migration at a reasonable rate, it was found that increasing amounts of water accelerated the formation of the dynamic combinatorial library due to the increased polarity of the solvent, but also increased the extent of hydrolysis of the benzoyl group. In addition, the migration rate strongly depends on the concentration and pKb of the base and temperature. To minimize debenzoylation, anhydrous acetonitrile was used as the solvent, with DBU as a base. The optimal condition consisted of 1 mg of 1,4-dibenzoyl-chiro-inositol (compound 5) and 30 microL (79 eq) of DBU in 1 mL acetonitrile, which yielded full migration within one hour at room temperature. Generation of the nine isomers was confirmed by mass spectroscopy and UV analysis using LC-MS, as shown in FIG. 2.

FIG. 2 shows (a) HPLC chromatogram (C18 column: 4.6×150 mm, eluted with 18% acetonitrile in water) of 3,4-di-O-benzoyl-chiro-inositol before base addition; (b) chromatogram of the DCL at one hour after addition of DBU with 8% of 3,4-di-O-benzoyl-chiro-inositol (c) chromatogram of the DCL at seven hours after addition of 2 eq of PhB(OH)2 with 43& of 3,4-di-O-benzoyl-chiro-inositol; and (d) chromatogram of the DCL at seven hours after addition of PhB(OH)2 with 82% of 3,4-di-O-benzoyl-chiro-inositol.

Since it is well known that boronic acids form five-membered cyclic esters preferably with 1,2-cis-diols in sugar systems (James et al., 1996; Wiecko et al., 1979; Eggert et al., 1999; Arimori et al., 2001; Arimori et al., 2002; Yang et al., 2001; Cabell et al., 1999; James et al., 1995), the present inventors envisioned that only one isomer out of the nine, namely, 3,4-dibenzoyl-chiro-inositol, which carries two cis-vicinal diols, would have a higher binding affinity for two boronic acids, thus stopping further migration. Furthermore, it was also reported that the binding affinity of boronic acid with a sugar depends on the pH of the media. At pH lower than the pKa of boronic acid, i.e., acidic conditions, coupling between the boronic acid and a sugar is disfavored, while the coupling is favored at pH over the pKa of boronic acid, i.e., basic donations.

To test this hypothesis, 32 eq of phenyl boronic acid was added to the equilibrium mixture of the chiro-inositol dibenzoates in the presence of DBU. A dramatic equilibrium shift of mixtures toward 3,4-di-O-benzoyl-chiro-inositol, compound 7, characterized as 3,4-di-O-benzoyl-chiro-inositol by a separate synthesis (Khersonsky et al., 2002; Falshaw, 2000), was demonstrated, as shown in FIG. 2c. The isomer 3,4-di-O-benzoyl-chiro-inositol, initially 8% of the equilibrium mixture, as shown in FIG. 2b, became the major constituent of the library (82%) in seven hours after treatment with DBU, demonstrating and enrichment factor of 10.3.

It was envisioned that the nine regioisomers generated from compound 5, 3,6-di-O-benzoyl-chiro-inositol, would initially couple with one phenyl boronic acid at the moment one cis-diol in any component was exposed from benzoyl migration. Following that, the mono-boronic acid-coupled component will undergo further acyl migration until a second cis-diol is exposed and trapped by yet another phenyl boronic acid, as shown in FIG. 1. Benzoyl migration will terminate when two cis-diols of 3,4-di-O-benzoyl-chiro-inositol couple with two boronic acids, since free hydroxyl groups are no longer available. This effectively isolates this component from the equilibrating DCL, resulting in an accumulation of the “winning” binder. Thus, increased amounts of boronic acid will shift the equilibrium towards the selected compound, 3,4-di-O-benzoyl-chiro-inositol. With 1, 2, 6 and 32 equivalents of phenyl boronic acid, the final amount of 3,4-di-O-benzoyl-chiro-inositol was 25%, 43%, 67%, and 82%, respectively. However, amounts of phenyl boronic acid in excess of 32 equivalents did not further amplify 3,4-di-O-benzoyl-chiro-inositol. The final distribution of the regioisomers is “quenched” by treating the reaction mixture with MP-TsOH resin that removes DBU and stops acyl migration. This “quenched” distribution allows for a practical isolation of the product with a simple purification.

Thus, the present invention provides an efficient molecular evolution model in combining the base-catalyzed intramolecular acyl migration of inositol dibenzoate and a boronic acid selector. In the nonlimiting example described above, it was possible to amplify and accumulate from the equilibrium mixture up to 82% of one component, 3,4-di-O-benzoyl-chiro-inositol, out of a total of 9 isomers originating from 3,6-di-O-benzoyl-chiro-inositol. As a result, 3,6-di-O-benzoyl-chiro-inositol, as shown in FIG. 2a, efficiently evolved into 3,4-di-O-benzoyl-chiro-inositol (FIG. 2c) with a boronic acid selector via nine mutants (FIG. 2b). This is the first application of a boronic acid used to select and amplify a carbohydrate member of a DCL through intramolecular acyl migration.

The following nonlimiting examples are provided to illustrate the present invention and not to limit it.

Since it is well known that boronic acids form five-membered cyclic esters preferably with 1,2-cis diols in sugar systems,^{12,13} it was envisioned that only one isomer out of the nine, 3,4-dibenzoyl-chiro-inositol, which carries two cis-vicinal diols, would have a higher binding affinity for two boronic acids, thus stopping further migration. Furthermore, it was also reported that the binding affinity of boronic acid with a sugar depends on the pH of the media.¹³

### Materials Used

All reactions were performed with oven-dried glassware under positive nitrogen pressure. Unless otherwise noted, starting materials and solvents were purchased from Aldrich and Acros organics, and used without further purification. Analytical TLC was carried out on Merck 60 F254 silica gel plates (0.25 mm layer thickness) with visualization by UV light and/or spaying with a 5% solution of phosphomolybdic acid followed by charring with a heat gun. Column chromatography was performed on Merck 60 silica gel (230-400 mesh). ¹H-NMR (200 MHz) spectra were obtained on a Varian Gemini 200 spectrometer. Chemical shifts were reported in parts per million (ppm) relative to the internal standard tetramethylsilane (TMS). Coupling constants (J) are in Hertz (Hz). All compounds were identified by LC-MS (Agilent Technology) using a C18 column (4.6×150 mm, 70 minute elution using a solution of 18% CH₃CN-H₂O containing 1% acetic acid), with UV detection at λ=250 nm, and an electrospray ionization source.

### General Experimental Procedure for Molecular Evolution with Pre-Equilibrium

To a solution of 5 (1 mg, 2.6 μmol) in acetonitrile (1 mL) was added DBU (30 μL, 0.20 mmol) at room temperature. After shaking for 1 hour the full migration of 9 isomers was confirmed by HPLC-MS. Phenyl boronic acid was added to the reaction mixture (10 mg, 0.082 mmol) and was stirred for 7 hours. The distribution change was analyzed by HPLC-MS every hour. For freezing/quenching the distribution, the reaction mixture was filtered through MP-TsOH resin several times to remove DBU.

### General Experimental Procedure for Molecular Evolution without Pre-Equilibrium

To a solution of 5 (1 mg, 2.6 μmol) in acetonitrile (1 mL) were added phenyl boronic acid (10 mg, 0.082 mmol), and DBU (30 μL, 0.20 mmol) at room temperature. After stirring for 6 hours, the reaction mixture was analyzed by HPLC-MS.

### Synthesis of 1,2;4,5-di-O-Isopropylidene-3,6-di-O-Benzoyl-Chiro-Inositol (12)

To a solution of 1,2,4,5-di-O-isopropylene-3-O-benzoyl-chiro-inositol (10)¹¹ (172 mg, 0.47 mmol) in dichloromethane (10 mL) were added pyridine (0.23 mL, 2.8 mmol) and trifluromethanesulfonic anhydride (0.20 mL, 1.2 mmol) at −15° C., and the temperature allowed to rise to room temperature After 2 hours, the reaction mixture was diluted with ethyl acetate, washed with cold 1 N HCl solution, saturated NaHCO₃, and brine, dried over MgSO₄, concentrated, and chromatographed on silica gel (EA/Hex=1:10) to give a triflate 11, which was dissolved in DMF and to which lithium benzoate (120 mg, 0.94 mmol) was added. After stirring at room temperature for 1 day, the reaction mixture was diluted with ethyl acetate, washed with brine, dried over MgSO₄, concentrated, and chromatographed on silica gel (EA/Hex=1:10) to give 12 (190 mg, 86.0% in two steps).

### Synthesis of 3,6-Di-O-Benzoyl-Chiro-Inositol (5)

A solution of 2 (180 mg, 0.38 mmol) in 80% aqueous AcOH (6 mL) was heated at 100° C. for 2 hours, concentrated under vacuum, and chromatographed on silica gel (EA /Hex=3:1) to give 5 (110 mg, 73%) ¹H NMR (CDCl₃) 3.94-4.08 (2H, m), 4.19 (2H, ddd, J=3.6, 7.6, 9.8), 5.44 (1H, t, J=9.8), 5.53(1H, t, J=3.6), 7.40-7.58 (6H, m), 7.99-8.10 (4H, m); LC-MS: m/z: 389 [M+1]⁺, 371 [M-H₂O+1]⁺

### Synthesis of 3,4-Di-O-Benzoyl-1,2;5,6-di-O-Isopropylidene-Chiro-Insoitol (14)

To a solution of 1,2;5,6-di-O-isopropylidene-chiro-inositol (13)¹¹ (500 mg, 1.9 mmol) in DMF (2 mL) and pyridine (3 mL) was added benzoyl chloride (750 mg, 4.9 mmol). The reaction mixture was stirred for 3 hours at room temperature, diluted with ethyl acetate, washed with water, dried over MgSO₄, concentrated, and chromatographed on silica gel to give 14 (703 mg, 78.2%).

### Synthesis of 3,4-Di-O-Benzoyl-1,2;5,6-Chiro-Inositol (7)

To a solution of 14 (300 mg, 0.64 mmol) in THF (10 mL) and MeOH (2 mL) was added concentrated HCl (0.3 mL). The reaction mixture was stirred for 3 hours. The solvent was removed, and the reaction mixture was diluted with ethyl acetate, washed with water, dried over MgSO₄, and concentrated under vacuum. The compound was purified by recrystallization with ethyl acetate and hexane to give 7 (170 mg, 68.4%). 1H-NMR (CDCl₃+MeOH) δ4.15 (2H, t, J=2.4), 4.20 (2H, dd, J=4.0, 6.6), 5.65 (2H, dd, J=2.8, 6.76), 7.31-7.50 (6H, m), 7.92-7.97 (4H, m); LC-MS: m/z: 389 [M+1]⁺

Reaction Conditions: dibenzoyl chiro inositol (5) (1 mg), DBU (30 μL, 79 eq.) in acetonitrile (1 mL) with various amounts of phenyl boronic acid

Reaction conditions: dibenzoyl chiro-inositol (5) (1 mg), DBU (30 μL, 79 eq.) in acetonitrile (1 mL) with phenyl boronic acid (10 mg, 32 eq.)

The foregoing description of the specific embodiments of the present invention will so fully reveal the general nature of the invention that others can, by applying current knowledge, readily modify and/or adapt for various application such specific embodiments without undue experimentation and without departing from the generic concept. Therefore, such adaptations and modifications should and are intended to be comprehended within the meaning and range of equivalents of the disclosed embodiments.

It is to be understood that the phraseology or terminology employed herein is for the purpose of description and not of limitation. The means and materials for carrying out disclosed functions may take a variety of alternative forms without departing form the invention. Thus, the expressions “means to . . .” and “means for . . .” as may be found the specification above, and/or in the claims below, followed by a functional statement, are intended to define and cover whatever structural, physical, chemical, or electrical element or structures which may now or in the future exist for carrying out the recited function, whether or not precisely equivalent to the embodiment or embodiments disclosed in the specification above, and it is intended that such expressions be given their broadest interpretation.

### References

(1) (a) Otto, S.; Furlan, R. L. E.; Sanders, J. K. M. Curr. Opin. Chem. Biol., 2002, 6, 321-327; (b) Furlan, R. L. E.; Otto, S.; Sanders, J. K. M. Proc. Natl. Acad. Sci. USA., 2002, 99, 4801-4804; (c) Rowan, S. J.; Cantrill, S. J.; Cousins, G. R. L.; Sanders, J. K. M.; Stoddart, J. F. Angew. Chem. Int. Ed., 2002, 41, 898-952; (d) Ramström, O.; Bunyapaiboonsri, T.; Lohmann, S.; Lehn, J. M. Biochim. Biophys. Acta, 2002, 1572, 178-186; (e) Lehn, J. M.; Eliseev, A. V. Science, 2001, 291, 2331-2332; (f) Karan, C.; Miller, B. L. Drug Discov. Today, 2000, 5, 67-75; (g) Ganesan, A. Angew. Chem. Int. Ed., 1998, 37, 2828-2831.

(2) (a) Brady, P. A.; Bonar-Law, R. P.; Rowan, S. J.; Suckling, C. J.; Sanders, J. K. M. Chem. Commun., 1996, 319-320; (b) Rowan, S. J.; Brady, P. A.; Sanders, J. K. M. Angew. Chem. Int. Ed., 1996, 35, 2143-2145; (c) Rowan, S. J.; Brady, P. A.; Sanders, J. K. M. Tetrahedron Lett., 1996, 37, 6013-6016; (d) Rowan, S. J.; Sanders, J. K. M. J. Org. Chem., 1998, 63, 1536-1546; (e) Brady, P. A.; Sanders, J. K. M. J. Chem. Soc., Perkin Trans. 1, 1997, 3237-3253; (f) Kaiser, G.; Sanders, J. K. M. Chem. Commun., 2000, 1763-1764.

(3) (a) Swann, P. G.; Casanova, R. A.; Desai, A.; Frauenhoff, M. M.; Urbancic, M.; Slomczynska, U.; Hopfinger, A.; Le Breton, G. C.; Venton, D. L. Biopolymers, 1996, 40, 617-625; (b) Lins, R. J.; Flitsch, S. L.; Turner, N. J.; Irving, E.; Brown, S. A. Angew. Chem., Int. Ed., 2002, 41, 3405-3407.

(4) (a) Roberts, S. L.; Furlan, R. L. E.; Otto, S.; Sanders, J. K. M. Org. Biomol. Chem., 2003, 1, 1625-1633; (b) Furlan, R. L. E.; Ng, Y. F.; Cousins, G. R. L.; Redman, J. E.; Sanders, J. K. M. Tetrahedron, 2002, 58, 771-778; (c) Furlan, R. L. E.; Ng, Y. F.; Otto, S.; Sanders, J. K. M. J. Am. Chem. Soc., 2001, 123, 8876-8877; (d) Cousins, G. R. L.; Furlan, R. L. E.; Ng, Y. F.; Redman, J. E.; Sanders, J. K. M. Angew. Chem., Int. Ed., 2001, 40, 423-428; (e) Huc, I.; Lehn, J. M. Proc. Natl. Acad. Sci. USA, 1997, 94, 2106-2110; (f) Star, A.; Goldberg. I.; Fuchs, B. Angew. Chem., Int. Ed., 2000, 39, 2685-2689; (g) Storm, O.; Lüning, U. Chem. Eur. J. 2002, 8, 793-798; (h) Nazarpack-Kandlousy, N.; Zweigenbaum, J.; Henion, J.; Eliseev, A. V. J. Comb. Chem., 1999, 1, 199-206; (i) Gousins, G. R. L.; Poulsen, S. A.; Sanders, J. K. M. Chem. Commun., 1999, 1575-1576; (j) Bunyapaiboonsri, T.; Ramström, O.; Lohmann, S.; Lehn, J. M.; Peng, L; Goeldner, M. ChemBioChem., 2001, 2, 438-444; (k) Hochgurtel, M; Kroth, H.; Piecha, D.; Hofmann, M. W.; Nicolau, C.; Krause, S.; Schaaf, O.; Sonnenmoser, G.; Eliseev, A. Proc. Natl. Acad. Sci. USA, 2002, 99, 3382-3387; (l) Kuhnert, N.; Rossignolo, G. M.; Lopez-Periago, A. Org. Biomol. Chem., 2003, 1, 1157-1170.

(5) Giger, T.; Wigger, M.; Audetat, S.; Benner, S. A. Synlett., 1998, 688-692.

(6) (a) Otto, S.; Furlan, R. L. E.; Sanders, J. K. M. Science, 2002, 297, 590-593; (b) Otto, S.; Rurlan, R. L. E.; Sanders, J. K. M. J. Am. Chem. Soc., 2000, 122, 12063-12064; (c) Ramström, O.; Lehn, J. M. ChemBioChem., 2000, 1, 41-48; (d) Hioki, H.; Still, W. C. J. Org. Chem., 1998, 63, 904-905.

(7) (a) Eliseev, A. V.; Nelen, M. I. J. Am. Chem. Soc., 1997, 119, 1147-1148; (b) Eliseev, A. V.; Nelen, M. I. Chem. Eur. J., 1998, 4, 825-834.

(8) (a) Crego-Calama, M.; Hulst, R.; Fokkens, R.; Nibbering, N. M. M.; Timmerman, P.; Reinhoudt, D. N. Chem. Commun., 1998, 1021-1022; (b) Crego-Calama, M.; Timmerman, P.; Reinhoudt, D. N. Angew. Chem., Int. Ed., 2000, 39, 755-758; (c) Hof, F.; Nuckolls, C.; Rebek, J. J. Am. Chem. Soc., 2000, 122, 4251-4252.

(9) (a) Epstein, D. M.; Choudhary, S.; Churchill, R. M.; Keil, K. M.; Eliseev, A. V.; Morrow, J. R. Inorg. Chem., 2001, 40, 1591-1596; (b) Choudhary, S.; Morrow, J. R. Angew. Chem., Int. Ed., 2002, 41, 4096-4098; (c) Huc, I.; Krische, M. J.; Funeriu, D. P.; Lehn, J. M. Eur. J. Inorg. Chem., 1999, 1415-1420; (d) Stulz, E.; Ng, Y. F.; Scott, S. M.; Sanders, J. K. M. Chem. Commun., 2002, 524-525; (e) Ziegler, M.; Miranda, J. J.; Andersen, U. N.; Johnson, D. W.; Leary, J. A.; Raymond, K. N. Angew. Chen., Int. Ed., 2001, 40, 733-736; (f) Albrecht, M.; Blau, O.; Fröhlich, R. Chem. Eur. J., 1999, 5, 48-56; (g) Hiraoke, S.; Fujita, M. J. Am. Chem. Soc., 1999, 121, 10239-10240; (h) Kubota, Y.; Sakamoto, S.; Yamaguchi, K.; Fujita, M. Proc. Natl. Acad. Sci. USA, 2002, 99, 4854-4856; (i) Sakai, S.; Shigemasa, Y.; Sasaki, T. Tetrahedron Lett., 1997, 38, 8145-8148; (j) Klekota, B.; Hammond, M. H.; Miller, B. L. Tetrahedron Lett., 1997, 38, 8639-8642; (k) Klekota, B.; Miller, B. L. Tetrahedron, 1999, 55, 11687-11697; (l) Karan, C.; Miller, B. L. J. Am. Chem. Soc., 2001, 123, 7455-7456; (m) Case, M. A.; McLendon, G. L. J. Am. Chem. Soc., 2000, 122, 8089-8090; (n) Constable, E. C.; Housecroft, C. E.; Kulke, T.; Lazzarini, C.; Schofield, E. R.; Zimmermann, Y. J. Chem. Soc., Dalton Trans., 2001, 2864-2871; (o) Goral, V.; Nelen, M. I.; Eliseev, A. V.; Lehn, J. M. Proc. Natl. Acad. Sci. USA, 2001, 98, 1347-1352.

(10) (a) Chung, S. K.; Chang, Y. T. J. Chem; Soc., Chem. Commun., 1995, 13-14; (b) Chung, S. K.; Chang, Y. T.; Ryu, Y. Pure App. Chem., 1996, 68, 931-935.

(11) For synthesis of inositol derivatives, refer to supplementary information, and (a) Khersonsky, S. M.; Chang, Y. T. Carbohydr. Res., 2002, 337, 75-78; (b) Falshaw, A.; Hart, J. B.; Tyler, P. C. Carbohydr. Res., 2000, 329, 301-308.

(12) (a) James, T. D.; Sandanayake, S.; Shinkai, S. Angew. Chem., Int. Ed., 1996, 35, 1910-1922; (b) Wiecko. J.; Sherman, W. R. J. Am. Chem. Soc., 1979, 101, 979-983.

(13)(a) Eggert, H.; Frederiksen, J.; Morin, C.; Norrild, J. C. J. Org. Chem., 1999, 64, 3846-3852; (b) Arimori, S.; Bell, M.; L; Oh, C. S.; Frimat, K. A.; James, T. D. Chem. Commun., 2001, 1836-1837; (c) Arimori, S.; Ushiroda, S.; Peter, L. M.; Jenkins, A. T. A.; James, T. D. Chem. Commun., 2002, 2368-2369; (d) Yang, W.; He, H.; Drueckhammer, D. G. Angew. Chem., Int. Ed., 2001, 40, 1714-1718; (e) Cabell, L. A.; Monahan, M. K.; Anslyn, E. V. Tetrahedron Lett., 1999, 40, 7753-7756; (f) James, T. D.; Sandanayake, S.; Iguchi, R.; Shinkai, S. J. Am. Chem. Soc., 1995, 117, 8982-8987.

What is claimed is:

1. A method for generating a dynamic carbohydrate library comprising subjecting a carbohydrate scaffold to intramolecular acyl migration using a boronic acid selector.

2. The method according to claim 1 wherein the carbohydrate scaffold is a monomeric carbohydrate.

3. The method according to claim 1 wherein the carbohydrate scaffold is selected from the group consisting of dimmers and oligomers having monomers connected by an ester bond.

4. The method according to claim 1 wherein the boronic acid selector is phenyl boronic acid.

5. The method according to claim 1 wherein the generating is conducted in a basic medium.

6. The method according to claim l wherein the carbohydrate scaffold is inositol.

7. The method according to claim 7 wherein the inositol is chiro-inositol.
